(19) United States
(12) Patent Application Publication
(10) Pub. No.: US 2026/0251105 A1
(43) Pub. Date: Aug. 27, 2026

(54) THRUST REVERSER MODULE OF A THRUST REVERSER RING FOR AN AIRCRAFT NACELLE THRUST REVERSER

(71) Applicant: SAFRAN NACELLES, Gonfreville-l’Orcher (FR)

(72) Inventors: Bertrand Léon Marie DESJOYEAUX, Moissy-Cramayel (FR); Laurent Georges VALLEROY, Moissy-Cramayel (FR); Mathieu François Eric PREAU, Moissy-Cramayel (FR)

(73) Assignee: SAFRAN NACELLES, Gonfreville-l’Orcher (FR)

(21) Appl. No.: 19/160,342

(22) PCT Filed: Feb. 28, 2024
(86) PCT No.: PCT/FR2024/050256

§ 371 Date: Aug. 27, 2025

(30) Foreign Application Priority Data
Feb. 28, 2023 (FR) 2301841

(51) Int. Cl. F02K 1/60

(52) U.S. Cl. CPC F02K 1/60

(57) ABSTRACT

A thrust reverser module of a thrust reverser ring for an aircraft nacelle thrust reverser, characterized in that the thrust reverser module includes: a first spar which extends along a longitudinal direction and carries blading elements each extending transversely relative to the longitudinal direction, the transverse blading elements being distributed along the first spar, a second spar which extends parallel and adjacent to the first spar, and at least part of the transverse blading elements of the first spar being connected to the second spar.

### TECHNICAL FIELD

The present disclosure relates to a thrust reverser module of a thrust reverser ring for an aircraft nacelle thrust reverser, a thrust reverser ring comprising such a module and an aircraft nacelle comprising such a thrust reverser ring.

### PRIOR ART

It is known to equip the aircraft nacelles with thrust reverser cascades in order to be able to generate counter-thrust when the aircraft's operating conditions require it. Conventionally, the thrust reverser cascades form a ring surrounding the nacelle and each cascade comprises bladings whose orientation deflects the propulsive air flow towards the front of the jet engine when the cascades are deployed. These cascades are generally fixed to the structure of the nacelle by a front end and an opposite rear end of each cascade. These cascades generally have a rectangular shape with a duckboard architecture that comprises a plurality of parallel spars, each extending axially along a longitudinal direction, and a plurality of blading elements that extend transversely between the spars.

Known thrust reverser cascades are manufactured using methods that may lead to disruptive architectures for the air flow passing through these cascades.

In view of the above, it would therefore be interesting to design a thrust reverser module structure which disturbs the air flow passing through the module as little as possible.

### DISCLOSURE OF THE INVENTION

The object of the invention is thus a thrust reverser module of a thrust reverser ring for an aircraft nacelle thrust reverser, characterized in that the thrust reverser module comprises:
a first spar which extends along a longitudinal direction and carries blading elements each extending transversely relative to the longitudinal direction, the transverse blading elements being distributed along the first spar,
a second spar which extends parallel to the first spar and comprises first and second opposite large faces,
at least part of the transverse blading elements of the first spar being connected to the facing first large face of the second spar, the second large face of the second spar carrying transverse blading elements which each extend transversely relative to the longitudinal direction of the second spar, away from an area of the second spar, called connection area of the considered blading element, and in a direction opposite to the first large face of the second spar, the transverse blading elements of said at least part of the transverse blading elements of the first spar each being connected to the first large face of the second spar, between two successive connection areas of two successive transverse blading elements carried by the second large face of the second spar, so that the transverse blading elements of said at least part of the transverse blading elements of the first spar connected to the second spar and the transverse blading elements carried by the second large face of the second spar form a staggered arrangement relative to the second spar.

The architecture of this module is simple in design and thus allows producing a module by assembling two adjacent spars using blading elements carried by a first spar and which are directly fixed on the second spar. This configuration is particularly favorable to the flowing of air passing through the module during its use in a thrust reverser ring because this flowing of air will be very little disturbed by running alongside the blading elements. On the contrary, the flowing of air would be more strongly disturbed in an architecture where two adjacent spars are fixed together by means of the facing distal ends of the blading elements carried by these two spars. Indeed, the junction between the facing distal ends of the blading elements of the two spars proves to be an element disrupting the flowing. Moreover, in the aforementioned module, the transverse blading elements of the first spar are connected/assembled on the first large face of the second spar, between the areas of the second spar where the transverse blading elements carried by the second large face of the second spar are connected to the second large face of the second spar. This assembly arrangement offers the possibility of leaving free access to the areas of the second large face of the second spar which are each respectively arranged between two connection areas between, on the one hand, the transverse blading elements of the second large face of the second spar and, on the other hand, the second large face of the second spar. Thus, depending on the circumstances, it is possible to access, from these areas of the second large face of the second spar which are left free, the fixing means cooperating with or used on the second spar (on the side of the first large face) to cooperate with complementary fixing means carried by the blading elements of the first spar. Such access allows, for example, accessing at least part of these fixing means, or ensuring the locking of these fixing means or even reinforcing their mechanical connection with the second spar. Such flexibility of use is not possible if the blading elements of the first spar were each connected to the first large face of the second spar, in line with the connection area of a transverse blading element carried by the second large face of the second spar. Access to these fixing means on the side of the second large face of the second spar would then be hidden by the blading elements and therefore impossible. This arrangement also offers the possibility of using a wide variety of possible fixing means, which cannot be envisaged in the aforementioned case. Moreover, the assembly of the transverse blading elements carried by the first spar with the first large face of the second spar in areas of the second spar that are free of any connection, on the side of the second large face of the second spar, with transverse blading elements, makes it possible not to weaken the connection areas between these transverse blading elements and the second large face of the second spar. The second spar thus has an improved mechanical strength.

According to other possible characteristics, taken alone or in combination:
the transverse blading elements of said at least part of the transverse blading elements of the first spar each include a distal end which is configured to be assembled to the second spar by means of fixing means between the transverse blading elements and the second spar;
the module includes first fixing means carried by the transverse blading elements and second complementary fixing means carried by the second spar;
the first fixing means and the second complementary fixing means are of the mortise-and-tenon type;
the blading elements carry at their distal end at least one tenon-forming element and the second spar carries mortise-forming elements in geometric correspondence with the position of the facing tenons-forming elements;
the first large face of the second spar carries transverse blading elements which each extend transversely relative to the longitudinal direction of the second spar, the transverse blading elements carried by the first large face of the second spar being offset longitudinally with respect to the transverse blading elements carried by the second large face of the second spar so that the blading elements carried by the two opposite large faces form a staggered arrangement;
the first large face of the second spar carries blading elements which each extend transversely relative to the longitudinal direction of the second spar, the blading elements of said at least part of the blading elements of the first spar each being connected to the first large face of the second spar, between two successive blading elements carried by the first large face of the second spar;
the second large face of the second spar carries blading elements which each extend transversely relative to the longitudinal direction of the second spar, the blading elements carried by the second large face being disposed symmetrically with respect to the blading elements carried by the first large face, a blading element on one of the two opposite large faces of the second spar being disposed longitudinally facing a blading element on the other opposite large face of the spar;
the second large face of the second spar carries blading elements which each extend transversely relative to the longitudinal direction of the second spar, the blading elements carried by the second large face being offset longitudinally with respect to the blading elements carried by the first large face (staggered arrangement) and each extend transversely away from an area of the second spar called connection area of the blading element, in a direction opposite to the first large face, the blading elements of said at least part of the blading elements of the first spar being each connected to the first large face of the second spar, between two successive connection areas of two successive blading elements carried by the second large face;
the module further comprises at least a third spar which extends along a longitudinal direction parallel to the first and second spars, the third spar being assembled to the first or to the second spar by connection of blading elements carried by one of the spars to the other spar;
said at least one third spar carries blading elements each extending transversely relative to the longitudinal direction of the third spar while being distributed along the third spar.

The object of the invention is also a thrust reverser ring for an aircraft nacelle thrust reverser, comprising one or more thrust reverser modules as briefly set out above.

The object of the invention is further an aircraft nacelle comprising such a thrust reverser ring for an aircraft nacelle thrust reverser.

The object of the invention is also a method for producing a thrust reverser module of a thrust reverser ring for an aircraft nacelle thrust reverser, characterized in that the method comprises the following steps:
providing a first spar which extends along a longitudinal direction and which carries blading elements each extending transversely relative to the longitudinal direction, the transverse blading elements being distributed along the first spar,
providing a second spar which comprises first and second opposite large faces, the second large face of the second spar carrying transverse blading elements which each extend transversely relative to the longitudinal direction of the second spar, away from an area of the second spar, called connection area of the considered blading element, and in a direction opposite to the first large face of the second spar,
positioning the second spar parallel and adjacent to the first spar,
connecting at least part of the transverse blading elements of the first spar to the facing first large face of the second spar, the transverse blading elements of said at least part of the transverse blading elements of the first spar each being connected to the first large face of the second spar, between two successive connection areas of two successive transverse blading elements carried by the second large face of the second spar so that the transverse blading elements of said at least part of the transverse blading elements of the first spar connected to the second spar and the transverse blading elements carried by the second large face of the second spar form a staggered arrangement relative to the second spar.

The method has the same advantages as those set out above in relation to the module. Generally, the two spars which are independent of each other (separated) at the beginning of the method are assembled together, that is to say joined, in order to form a module by connecting at least some of the blading elements of the first spar with the second spar. Moreover, all or part of the characteristics of the module presented above may also be the object of one or more additional characteristics of the method.

### BRIEF DESCRIPTION OF THE DRAWINGS

Other characteristics and advantages of the object of the present disclosure will emerge from the following description of embodiments, given as non-limiting examples, with reference to the appended figures.

FIG. 1 is a schematic general view of an aircraft nacelle comprising a thrust reverser ring according to one embodiment of the invention;

FIG. 2 is a partial schematic general view of a thrust reverser module of an aircraft jet engine according to a first embodiment of the invention;

FIG. 3A is a partial schematic perspective view of one end of a blading element of the thrust reverser module of FIG. 2;

FIG. 3B is a partial schematic view, similar to that of FIG. 3A, of one end of a blading element of the thrust reverser module of FIG. 2 according to one variant of embodiment;

FIG. 3C is a partial schematic view, similar to that of FIG. 3B, of one end of a thrust reverser module blading element according to another variant of embodiment;

FIG. 4 is a partial schematic general view of a thrust reverser module of an aircraft jet engine according to one variant of embodiment of the mode of FIG. 2;

FIG. 5 is a partial schematic general perspective view of a thrust reverser module of an aircraft jet engine according to a second embodiment of the invention;

FIG. 6 is a partial schematic general view of a thrust reverser module of an aircraft jet engine according to a third embodiment of the invention;

FIG. 7 is a partial schematic top view showing a thrust reverser module according to a fourth embodiment of the invention;

FIG. 8 is a partial schematic top view showing a thrust reverser module according to a fifth embodiment of the invention;

FIG. 9 is a partial schematic view of a mortise-and-tenon assembly between a spar and a blading element.

### DETAILED DESCRIPTION

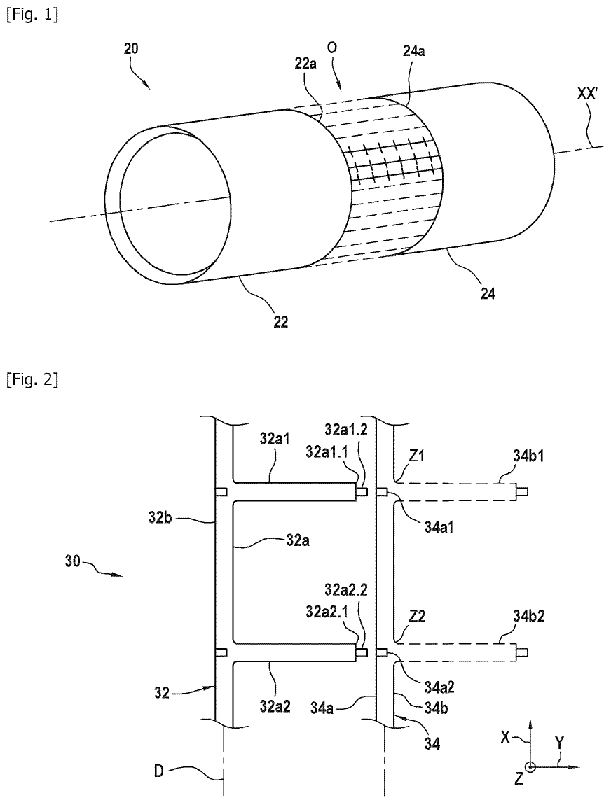

FIG. 1 illustrates an aircraft nacelle 20 of known type, comprising, aligned along the longitudinal axis XX', a front cowling 22 and a rear cowling 24 delimiting therebetween an annular opening O intended to accommodate a thrust reverser ring for an aircraft nacelle thrust reverser. The thrust reverser comprises in particular, in addition to the thrust reverser ring, actuators which, when controlled by one or more actuating unit(s) (engine(s)), allow activating the functional elements of the ring and therefore deflecting in a controlled manner the air flow passing through the ring. The aircraft nacelle forms, with the engine or turbomachine, a propulsion assembly of the aircraft.

To produce a thrust reverser ring according to one embodiment of the invention, a plurality of thrust reverser ring modules of the type of those described below are used to constitute thrust reverser ring cascades which are then placed on the nacelle. A cascade is for example formed of several spars (for example from 2 to 40 spars) assembled together as described below.

As represented in FIG. 2 (top view) and generally designated by the reference 30, a thrust reverser module according to a first embodiment generally comprises a first spar 32 and a second spar 34 which is positioned adjacent to the first spar and parallel thereto.

The first spar 32 extends along a longitudinal direction D and carries blading elements, only two of which are represented here, 32a1, 32a2 (the number of blading elements is generally much greater than two), and which each extend transversely relative to the longitudinal direction D. The transverse blading elements 32a1, 32a2 are distributed, generally evenly, over the length of the spar 32 and are secured to it. In practice, the spars and the blading elements can be produced in a single piece by injection manufacturing in an injection mold. More particularly, the first spar 32 and the transverse blading elements 32a1, 32a2 form part of a single piece manufactured integrally. The second spar 34, for its part, is not derived from the material with the transverse blading elements 32a1, 32a2 of the first spar 32.

As represented in FIG. 2, the first spar 32 comprises two opposite large faces which extend mainly, in a three-dimensional reference frame X, Y, Z, along two axes X (longitudinal direction) and Z (height or radial direction when the module is installed on the nacelle): a first large face 32a to which the blading elements 32a1, 32a2 are connected, extending along the third axis Y (width) away from this large face and a second opposite large face 32b which, in this mode, does not carry any blading elements. It will be noted that in another embodiment not represented, the second opposite large face 32b may carry blading elements which extend in a direction opposite to that of the blading elements 32a1, 32a2.

The second spar 34 also comprises first and second opposite large faces 34a, 34b, the first large face 34a being disposed facing the first large face 32a and the blading elements 32a1, 32a2 carried by the first large face.

The second large face 34b of the second spar 34 here also carries blading elements 34b1, 34b2 (two in number in this example; the remark applied to the blading elements of the first spar also applies here) and which each extend transversely relative to the longitudinal direction of the second spar 34, away from an area z1, z2 of the second spar called connection area of the considered blading element. More particularly, the second spar 34 and the transverse blading elements 34b1, 34b2 form part of a single piece manufactured integrally.

In this embodiment, the blading elements 32a1, 32a2 of the first spar 32 are disposed at the same axial dimension or position (along the axis X) along the first spar as the axial dimension or position of the blading elements 34b1, 34b2 of the second spar 34 along this spar. In other words, the blading elements 32a1, 32a2 are aligned transversely (along the direction Y) with the blading elements 34b1, 34b2.

As represented in FIG. 2, the blading elements 32a1, 32a2 of the first spar 32 are each assembled on the first large face 34a of the second spar 34 by connection to this face 34a, in line with the connection area z1, z2 of a blading element 34b1, 34b2 carried by the second large face 34b and which extends in a direction opposite to the face 34a. It will be noted that here all the blading elements 32a1, 32a2 of the first spar 32 participate in the assembly with the second spar, which allows ensuring a solid and reliable assembly between the two spars. However, according to one variant not represented, only some of the blading elements carried by the first large face 32a can be used for the assembly.

The assembly between the blading elements (or only part of them) of the first spar 32 and the first large face 34a of the second spar 34 is generally carried out by using first and second mechanical fixing means complementary to each other, for example of the mortise-and-tenon type, which are distributed between the blading elements of the first spar 32 carrying first fixing means and the first large face 34a of the second spar 34 carrying second fixing means complementary to the first means.

The blading elements 32a1, 32a2 of the first spar 32 each include a distal end 32a1.1, 32a2.1 which is considered as free when it is not yet assembled with the second spar 34. Each distal end 32a1.1, 32a2.1 is configured to be assembled to the first large face 34a of the second spar by means of the first and second mechanical fixing means which are complementary to each other.

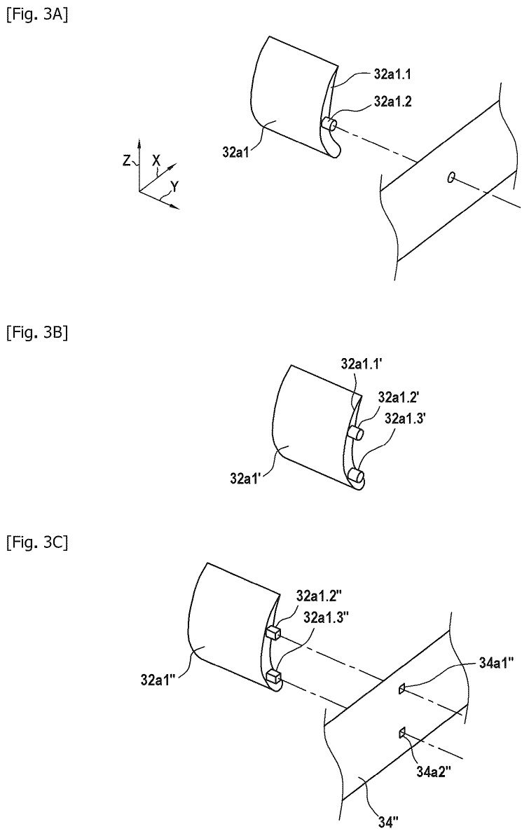

By way of example, the blading elements 32a1, 32a2 carry at their distal end 32a1.1, 32a2.1 at least one tenon-forming element 32a1.2, 32a2.2 (for example in the form of a pin) and the first large face 34a of the second spar carries mortises-forming elements 34a1, 34a2 (for example in the form of a cavity), of complementary shapes and which are arranged in geometric correspondence with the position of the facing tenons-forming elements. FIG. 3A illustrates in perspective the tenon 32a1.2 arranged on the distal end rim 32a1.1 of the blading element 32a1.

Thus, the tenons 32a1.2, 32a2.2 of the blading elements 32a1, 32a2 are forcibly inserted into the facing mortises, which allows assembling/securing the blading elements of the first spar 32 to the second spar 34. According to one variant not represented, the tenons and mortises are reversed between the blading elements and the second spar. With a mortise-and-tenon type assembly/connection (regardless of the element which carries the tenon), in a complementary manner, the tenons-forming elements can be bonded to the mortises-forming elements. Alternatively, in a complementary manner, the tenons-forming elements can be welded to the mortises-forming elements, particularly if the spars are made of metal or thermoplastic-matrix composite materials. Alternatively, in a complementary manner, the tenons-forming elements can be deformed to be prevented from coming out of the mortises-forming elements. Alternatively, in a complementary manner, a screw can be placed through the spar and press the blading element against the spar. Alternatively, in a complementary manner, the tenons-forming elements can be split along their length and clipped through the mortises-forming elements. Other complementary assembly/fixing means can alternatively be used between the blading elements and the second spar.

FIG. 3B illustrates one variant of embodiment showing two tenons 32a1.2′, 32a1.3′ arranged on the distal end rim 32a1.1′ of the blading element 32a1′. A different number of tenons or a single tenon-forming element having an elongated shape following the chord of the blading element can alternatively be envisaged.

FIG. 3C illustrates another variant with two tenons of different shapes, for example trapezoidal or square or even rectangular shape, 32a1.2″, 32a1.3″ arranged on the distal end rim 32a1.1″ of the blading element 32a1″. These elements are inserted into complementary shapes (through openings here) 34a1″ and 34a2″ of the spar 34″.

As represented in FIG. 2, the blading elements 34b1, 34b2 may also each carry one or more tenons and mortises may be produced on the second large face 32b of the first spar, as on the first large face 34a, in order to be able to assemble the elementary module of FIG. 2 with other identical modules by using the same principle of direct fixing/connection between blading elements and spar. A thrust reverser ring cascade is thus constituted step by step by the addition of additional spars (the module thus constituted is a multi-spar module which may be constituted of n spars with n greater than or equal to two and less than or equal to 5, or even n less than or equal to 40; when n is equal to 40 or close to 40, the module thus constituted may cover approximately 90° of the circumference of the reverser ring) which may be easily adjusted to the desired dimensions (depending on the needs).

It will be noted that the space between the two adjacent spars 32, 34 defines an aerodynamic inversion channel. This channel here comprises the transverse blading elements 32a1, 32a2 derived only from the first spar.

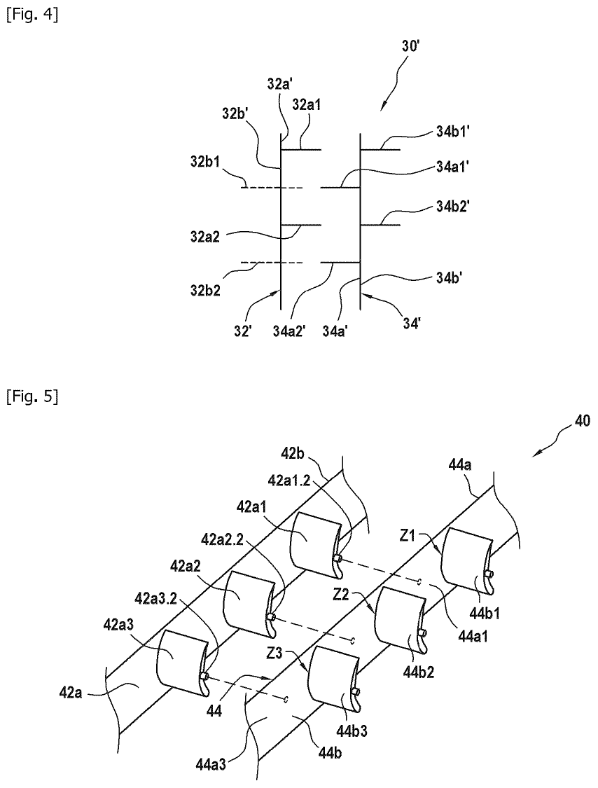

FIG. 4 illustrates a thrust reverser module 30′ according to a variant of embodiment in which the first large face 34a′ of the second spar 34′ carries blading elements 34a1′, 34a2′ (two in number in this example; the remark applied to the blading elements of the mode of FIG. 2 also applies here) which each extend transversely relative to the longitudinal direction of the second spar 34 in the direction of the first large face 32a′ of the first spar 32. The blading elements 34a1′, 34a2′ carried by the first large face 34a′ are offset longitudinally (along the length of the spar 34′) with respect to the blading elements 34b1′, 34b2′ carried by the second large face 34b′.

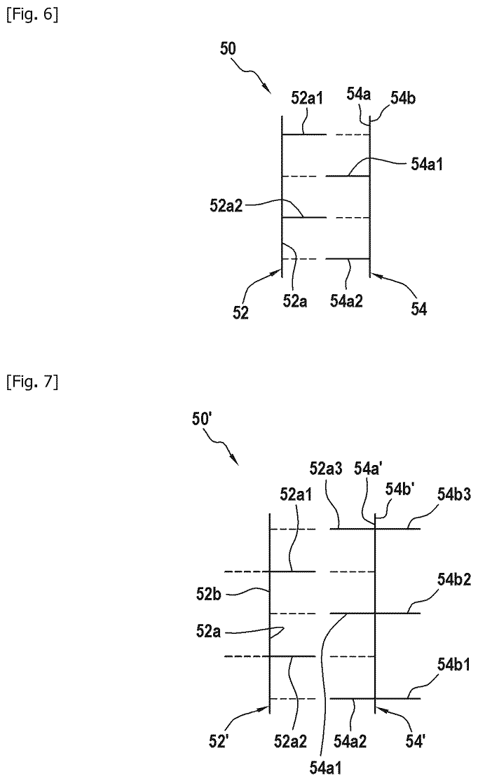

Thus, the blading elements 34a1′, 34a2′ are inserted between the blading elements carried by the first large face 32a′ of the first spar 32′ and, in this case, the blading element 34a1′ is interposed between the two consecutive blading elements 32a1, 32a2 (staggered arrangement). It should be noted that this arrangement can be obtained by longitudinally spacing the blading elements of the two spars 32 and 34 of FIG. 2 in order to add the blading elements 34a1′, 34a2′. This allows maintaining the same longitudinal spacing between the consecutive blading elements 32a1′, 34a1, 32a2′, 34a2 in the module thus assembled. Here again, as in the mode of FIG. 2, the space between the two adjacent spars 32, 34 defines an aerodynamic reverser channel which comprises the transverse blading elements 32a1, 32a2 derived from the first spar and the transverse blading elements derived from the second spar. This remark also applies to the modes of FIGS. 6, 7 and 8 which will be described later.

It will be noted that the first spar 32′ may, as illustrated in dotted lines, carry on its second opposite large face 32b′ blading elements 32b1, 32b2 which extend away from this large face. As in the mode of FIG. 2, the blading elements 34a1′, 34a2′ (FIG. 4) can be assembled with the large face 32a′ of the first spar by means of an identical mortise-and-tenon type fixing system, including or not including either of the additional fixing means, or even an alternative fixing system.

In this arrangement, the spar 32a′ thus also carries blading elements which are offset longitudinally (along the length of the spar 32′) from one large face to the other, as for the spar 34′. The two spars thus have an identical configuration (staggered arrangement) as illustrated in FIG. 4, which allows them to be interlocked at will to form a cascade from elementary modules assembled with each other.

FIG. 5 illustrates a thrust reverser module 40 according to a second embodiment which differs from the mode of FIG. 2 by a longitudinal offset between the blading elements 42a1, 42a2, 42a3 carried by the first large face 42a of the first spar 42 and the blading elements 44b1, 44b2, 44b3 carried by the second large face 44b of the second spar 44 (staggered arrangement with respect to the second spar when the blading elements 42a1, 42a2, 42a3 are connected to the second spar; in FIG. 5 the blading elements 42a1, 42a2, 42a3 are in an approach position with respect to the second spar 44 and not yet connected thereto).

More particularly, the blading elements 42a1, 42a2, 42a3 are each assembled on the first large face 44a of the second spar 44 by connection to this face 44a, between two successive connection areas Z1, Z2, Z3 of two successive blading elements 44b1, 44b2, 44b3 carried by the second large face 44b of the second spar 44. The assembly/connection means may be, here, as in the mode of FIG. 2, first and second mechanical fixing means complementary to each other, for example of the mortise-and-tenon type, which are distributed between the blading elements of the first spar 42 carrying first fixing means and the first large face 44a of the second spar 44 carrying second fixing means complementary to the first means. More particularly, the blading elements 42a1, 42a2, 42a3 each carry, at their distal end facing the large face 44a of the second spar, respectively a tenon-forming element 42a1.2, 42a2.2, 42a3.2 which interlocks into a mortise-forming element arranged in geometric correspondence on the facing large face 44a (for example the elements 44a1 and 44a3 in dotted lines). On the side of the second large face 44b of the second spar, it is thus possible to access the distal end of the tenons-forming elements which are engaged in the corresponding facing openings (mortises-forming elements mentioned above and visible in FIG. 5 in alignment with the tenons-forming elements) of the second spar 44 when these openings are through-openings. Depending on the configurations envisaged, the openings may or may not be through-openings, depending on whether or not access to the fixing means from the second large face 44b of the second spar is desired. The complementary assembly/fixing elements or means carried by the first large face 44a of the second spar 44 are offset longitudinally with respect to the blading elements 44b1, 44b2, 44b3 carried by the second large face 44b.

It will be noted that the blading elements 44b1, 44b2, 44b3 carried by the second large face 44b also carry tenons-forming elements which allow them to be assembled with the large face of another spar of another module 40. Similarly, the second large face 42b of the first spar carries mortises-forming elements in order to be able to be assembled in an identical manner with the blading elements of another module 40. The different modes of FIGS. 3A-3C described above can also be applied here, as well as the mode of FIG. 9 which will be described later. The arrangement illustrated in FIG. 5 shows that, on the side of the second large face 44b of the second spar 44, it is possible to access the area of the second spar left free between the connection areas Z1, Z2, Z3 (of the successive blading elements 44b1, 44b2, 44b3), where the blading elements 42a1, 42a2, 42a3 carried by the first large face 42a of the first spar 42 are connected/assembled/fixed to the first large face 44a of the second spar 44 (when the openings presented pass through the thickness of the second spar). It is thus possible to access the mechanical fixing/assembly between the blading elements 42a1, 42a2, 42a3 and the second spar 44 and, for example, to complete and/or reinforce this fixing or this mechanical assembly. The mode of FIG. 9 which will be described later thus illustrates one example of a fixing means for which the clear access on the side of the second large face 44b of the second spar 44 proves useful. This may also prove useful with other fixing means such as those of the modes of FIGS. 3A-3C.

Everything that has been said previously about the first mode of FIG. 2 and its variants also applies here (except with regard to the particularities of the assembly of the blading elements of the first spar in line with the connection areas Z1, Z2 of the second spar) and will not be repeated.

FIG. 6 illustrates a thrust reverser module 50 according to a third embodiment in which two adjacent parallel spars 52, 54 both carry blading elements but which, unlike the mode of FIG. 5, are directed in opposite directions to each other. The first spar 52 is identical to the spar 42 of FIG. 5 and the blading elements 52a1, 52a2 it carries on its first large face 52a are assembled with the first large face 54a, in a manner identical to the one described with reference to the mode of FIG. 5, as illustrated in dotted lines in FIG. 6. However, the blading elements 54a1, 54a2 carried by the first large face 54a which is facing the blading elements 52a1, 52a2 of the first spar 52 are oriented oppositely to the blading elements 44b1, 44b2, 44b3 of FIG. 5. The blading elements 54a1, 54a2 may be identical and carry tenons-forming elements to be assembled with the facing first large face 52a (see dotted lines between the large face 52a provided with mortises-forming elements and the blading elements 54a1, 54a2) and thus obtain a double assembly or not carry such elements (a single assembly is then carried out by means of the sole blading elements 52a1, 52a2 of the first spar 52 connected to the second spar 54).

FIG. 7 illustrates a thrust reverser module 50′ according to one variant of embodiment which differs from the module 50 of FIG. 6 in that the second large face 54b′ of the second spar 54′ also carries blading elements 54b1, 54b2, 54b3 which each extend transversely relative to the longitudinal direction of the second spar 54′. These blading elements carried by the second large face 54b′ are disposed symmetrically with respect to the blading elements 54a1, 54a2, 54a3 carried by the first large face 54a′, that is to say a first blading element carried by one face is disposed facing a second blading element carried by the opposite face and directed in a direction opposite to that of the first blading element (ladder arrangement).

As in the mode of FIG. 6, the blading elements 54a1, 54a2, 54a3 may or may not be assembled with the first large face 52a of the facing first spar 52′.

Moreover, the second large face 52b may also carry blading elements represented in dotted lines and which are disposed symmetrically with respect to the blading elements 54a1 and 54a2.

The two spars 52′, 54′ (with the blading elements represented in dotted lines) thus have an identical symmetrical configuration but offset longitudinally from one spar to the other as illustrated in FIG. 7, which allows interposing the blading elements of one spar with those of the facing spar. This architecture also allows interlocking them at will (blading elements-spar) to form a cascade from elementary modules assembled with each other.

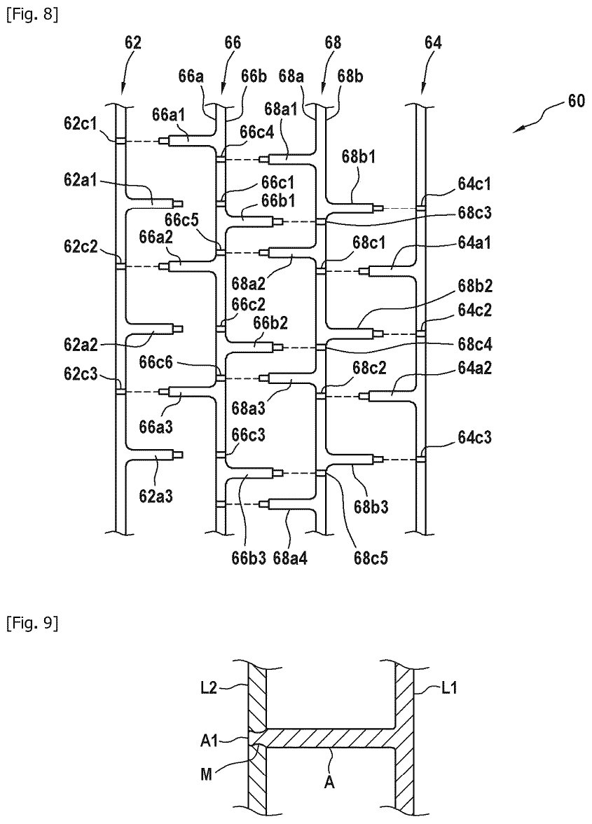

FIG. 8 illustrates a thrust reverser module 60 according to a fourth embodiment which includes four adjacent spars assembled by interlocking with each other two by two.

This mode is based on several previous modes/variants, namely the mode of FIG. 6 where the blading elements carried by the first large face of the first spar are assembled with the first large face facing the second spar, between two consecutive blading elements carried by the first large face facing the second spar, on the variant of FIG. 4 where the blading elements carried by the two opposite large faces of the second spar are offset longitudinally from one face to the other and, on the mode of FIG. 7 where the blading elements carried by the first large face of the first spar are assembled with the first large face facing the second spar, in areas located between two consecutive blading elements carried by the second opposite large face of the second spar.

More particularly, the module 60 of FIG. 8 comprises two end spars 62, 64 identical to the spar 52 of FIG. 6 and which frame two central spars 66, 68 having a structure of the type of that of the spar 34′ of FIG. 4 with the blading elements offset longitudinally from one face to the other.

Each end spar 62, 64 includes respective blading elements 62a1, 62a2, 62a3 and 64a1, 64a2 which are each oriented opposite a first large face 66a, 68b of the adjacent spar 66 and 68 and which are assembled with mortises-forming elements arranged on this face, namely 66c1, 66c2, 66c3 and 68c1, 68c2.

The first large face 66a, 68b of the spar 66, 68 carries respective blading elements 66a1, 66a2, 66a3 and 68b1, 68b2 which are assembled with mortises-forming elements arranged on the large face facing the corresponding end spar 62, 64, namely 62c1, 62c2, 62c3 and 64c1, 64c2.

Moreover, each central spar 66, 68 carries on its large face disposed facing the other large face of the other central spar of the blading elements 66b1, 66b2, 66b3 and 68a1, 68a2, 68a3, 68a4 which are assembled with mortises-forming elements arranged on the facing large face, namely respectively 68c3, 68c4 and 66c4, 66c5, 66c6.

It will be noted that each central spar thus comprises one, two or three mortises-forming elements between two consecutive blading elements carried by the same large face so as to allow the insertion of tenons-forming elements on each of the two opposite large faces of the spar.

The mortises-forming elements of each central spar are disposed between the successive connection areas of the successive blading elements.

FIG. 9 very schematically illustrates one possible example of a mortise-and-tenon assembly between a blading element A carried by a spar L1, provided with a tenon-forming element A1 and a mortise-forming element M made in an adjacent spar L2. The mortise-forming element M is here a through-hole and the tenon-forming element A1 is inserted into it on the side of a large face of the second spar L2 and its open end is then deformed, from the opposite large face of the second spar L2, for example by crushing, in order to prevent its axial withdrawal. In this mode, the clear access to the fixing/assembly means on the side of the opposite large face of the second spar L2 proves useful.

This assembly possibility also applies to the modes and variants described above and which may be concerned by such an assembly mode.

The various modules described above allows, from elementary segments comprising, in a minimal configuration with two assembled elementary segments (FIG. 2), a first spar carrying transverse blading elements and a second spar carrying means for receiving (e.g., mortises) transverse blading elements of the first spar (the second spar carrying or not carrying transverse blading elements), constituting reverser modules by assembly of these two elementary segments, or even more than two of these segments. With a limited number of patterns of elementary segments (elementary segments having different configurations), it is possible to carry out different arrangements of thrust reverser modules, possibly by combining several embodiments and/or variants of embodiment. The various embodiments and/or variants of embodiment differ from each other, in particular by the arrangement of the blading elements on the spars and their orientation.

A thrust reverser ring according to the invention may comprise only reverser modules according to either of the modes and variants described above, alone or combined with each other, or it may comprise such reverser modules according to either of the modes and variants described above, alone or combined with each other, as well as conventional thrust reverser cascades.

It will be noted that in any one of the modes and variants described above, the ring may be locally interrupted to take specific arrangements into account. It may thus be interrupted to leave a passage for a pylon or mast used to suspend the engine.

Generally, the ring that is the object of the invention does not, strictly speaking, extend over 360°, but it nevertheless has a thrust reverser structure in the general shape of a ring.

Although the present description refers to specific exemplary embodiments, modifications may be made to these examples without departing from the general scope of the invention as defined by the claims. Furthermore, individual characteristics of the various embodiments illustrated or mentioned may be combined in additional embodiments. Consequently, the description and the drawings should be considered in an illustrative rather than restrictive sense.

1. A thrust reverser module of a thrust reverser ring for an aircraft nacelle thrust reverser, characterized in that the thrust reverser module comprises:
a first spar which extends along a longitudinal direction and carries blading elements each extending transversely relative to the longitudinal direction, the transverse blading elements being distributed along the first spar,
a second spar which extends parallel to the first spar and comprises first and second opposite large faces,
at least part of the transverse blading elements of the first spar being connected to the facing first large face of the second spar, the second large face of the second spar carrying transverse blading elements which each extend transversely relative to the longitudinal direction of the second spar, away from an area of the second spar, called connection area of the considered blading element, and in a direction opposite to the first large face of the second spar, the transverse blading elements of said at least part of the transverse blading elements of the first spar each being connected to the first large face of the second spar, between two successive connection areas of two successive transverse blading elements carried by the second large face of the second spar, so that the transverse blading elements of said at least part of the transverse blading elements of the first spar connected to the second spar and the transverse blading elements carried by the second large face of the second spar form a staggered arrangement relative to the second spar.

2. The thrust reverser module according to claim 1, characterized in that the transverse blading elements of said at least part of the transverse blading elements of the first spar each include a distal end which is configured to be assembled to the second spar by means of fixing means between the transverse blading elements and the second spar.

3. The thrust reverser module according to claim 2, characterized in that it includes first fixing means carried by the transverse blading elements and second complementary fixing means carried by the second spar.

4. The thrust reverser module according to claim 1, characterized in that the first large face of the second spar carries blading elements which each extend transversely relative to the longitudinal direction of the second spar, the blading elements of said at least part of the blading elements of the first spar each being connected to the first large face of the second spar, between two successive blading elements carried by the first large face.

5. The thrust reverser module according to claim 1, characterized in that it comprises at least a third spar which extends along a longitudinal direction parallel to the first and second spars, the third spar being assembled to the first or to the second spar by connection of blading elements carried by one of the spars to the other spar.

6. A thrust reverser ring for an aircraft nacelle thrust reverser, characterized in that it comprises one or more thrust reverser modules according to claim 1.

7. A method for producing a thrust reverser module of a thrust reverser ring for an aircraft nacelle thrust reverser, characterized in that the method comprises the following steps:
providing a first spar which extends along a longitudinal direction and which carries blading elements each extending transversely relative to the longitudinal direction, the transverse blading elements being distributed along the first spar.
providing a second spar which comprises first and second opposite large faces, the second large face of the second spar carrying transverse blading elements which each extend transversely relative to the longitudinal direction of the second spar, away from an area of the second spar, called connection area of the considered blading element, and in a direction opposite to the first large face of the second spar,
positioning the second spar parallel and adjacent to the first,
connecting at least part of the transverse blading elements of the first spar to the facing first large face of the second spar, the transverse blading elements, of said at least part of the transverse blading elements of the first spar each being connected to the first large face of the second spar, between two successive connection areas of two successive transverse blading elements carried by the second large face of the second spar so that the transverse blading elements of said at least part of the transverse blading elements of the first spar connected to the second spar and the transverse blading elements carried by the second large face of the second spar form a staggered arrangement relative to the second spar.
